(19) United States
(12) Patent Application Publication
(10) Pub. No.: US 2025/0018734 A1
(43) Pub. Date: Jan. 16, 2025

(54) RECORDING APPARATUS

(71) Applicant: SEIKO EPSON CORPORATION, Tokyo (JP)

(72) Inventors: Haruki MIYASAKA, MATSUMOTO-SHI (JP); Soshi OKAWA, SHIOJIRI-SHI (JP); Nobuhiko SHINOZAKI, OKAYA-SHI (JP); Tomoya KURASHINA, SHIOJIRI-SHI (JP); Sho ARUGA, CHINO-SHI (JP)

(21) Appl. No.: 18/771,648

(22) Filed: Jul. 12, 2024

(30) Foreign Application Priority Data
Jul. 14, 2023 (JP) 2023-115663

(51) Int. Cl. B41J 11/00; B41J 11/58

(52) U.S. Cl. CPC B41J 11/007; B41J 11/00222; B41J 11/005; B41J 11/58

(57) ABSTRACT

A recording apparatus includes a recording unit configured to perform recording on a medium conveyed in a first direction, a recording-time conveying path facing the recording unit, a guide path located below the recording-time conveying path, the medium passed through the recording-time conveying path, a reversing path coupled to the guide path, the reversing path reversing the medium and causing the medium to join to the recording-time conveying path, a reversing roller disposed in the reversing path and configured to feed the medium downstream in the reversing path, a motor for reversing configured to drive the reversing roller, a first path forming section forming a lower surface of the recording-time conveying path, and a second path forming section forming an upper surface of the guide path. The motor for reversing is disposed at a position between the first path forming section and the second path forming section.

The present application is based on, and claims priority from JP Application Serial Number 2023-115663, filed Jul. 14, 2023, the disclosure of which is hereby incorporated by reference herein in its entirety.

### BACKGROUND

### 1. Technical Field

The present disclosure relates to a recording apparatus that performs recording on a medium.

### 2. Related Art

JP-2001-253138 discloses a printer in which a conveying path for recording paper is formed in a U-shape and a thermal head is disposed on the inner side of the U-shape. In this printer, a stepping motor, which is a power source for a grip roller that conveys the recording paper, is disposed on the inner side of the U-shape.

JP-A-2001-253138 is an example of the related art.

A motor is a heat source and, for example, when recording means is an inkjet recording head, it is likely that heat generated by the motor adversely affects ink ejection accuracy of the inkjet recording head. Even when the recording means is other than the inkjet recording head, there is concern about the influence by heat.

In the printer disclosed in JP-2001-253138, the stepping motor is disposed on the inner side of the U-shaped conveying path to reduce the size and the thickness of the apparatus. However, the stepping motor is disposed in the same space as a space where the thermal head is disposed. Therefore, heat generated in the stepping motor is directly transferred to the thermal head by radiation. The bad influence of the heat generated in the stepping motor on the thermal head is not considered. That is, the configuration disclosed in JP-2001-253138 is not a configuration in which not both of the reduction in the size and the heat generation of the motor are considered. In the following explanation, this is a first problem in the related art.

In the printer disclosed in JP-2001-253138, the stepping motor is provided in a state in which the stepping motor is exposed toward the upper surface of the apparatus. In the configuration explained above, operation sound of the motor easily leaks from the upper surface of the apparatus. The leakage of the noise from the upper surface of the apparatus easily becomes harsh to the user. There is room for improvement. That is, the configuration disclosed in JP-2001-253138 is not a configuration in which not both of the reduction in the size and quietness are considered. In the following explanation, this is a second problem in the related art. In the following explanation, this is a second problem in the related art.

As explained above, the related art has the first problem and the second problem. At least one of the first problem and the second problem is desired to be solved.

### SUMMARY

According to an aspect of the present disclosure, a recording apparatus includes: a recording unit configured to perform recording on a medium conveyed in a first direction; a recording-time conveying path that is a medium conveying path facing the recording unit; a guide path located below the recording-time conveying path, the guide path guiding, in a second direction opposite to the first direction, the medium passed through the recording-time conveying path; a reversing path coupled to the guide path, the reversing path reversing the medium and causing the medium to join the recording-time conveying path; a reversing roller disposed in the reversing path and configured to convey the medium downstream in the reversing path; a motor for reversing configured to drive the reversing roller; a first path forming section forming a lower surface of the recording-time conveying path; and a second path forming section forming an upper surface of the guide path, wherein the motor for reversing is disposed at a position between the first path forming section and the second path forming section.

### BRIEF DESCRIPTION OF THE DRAWINGS

FIG. 1 is an exterior perspective view of a printer.

FIG. 2 is a diagram of a medium conveying path of the printer viewed from the left side of the apparatus.

FIG. 3 is a block diagram illustrating a control system of the printer.

FIG. 4 is a cross-sectional view of a shutter, a cap unit, and a first path forming member in a state in which the shutter is present at a shielding position and the cap unit is present at a lowered position.

FIG. 5 is a cross-sectional view of the shutter, the cap unit, and the first path forming member in a state in which the shutter is present at an opening position and the cap unit is present at the lowered position.

FIG. 6 is a cross-sectional view of the shutter, the cap unit, and the first path forming member in a state in which the shutter is present at the opening position and the cap unit is present at a raised position.

FIG. 7 is a diagram of the medium conveying path of the printer viewed from the right side of the apparatus.

FIG. 8 is a diagram schematically illustrating components of the printer.

FIG. 9 is a plan view illustrating disposition of the components with respect to the first path forming member.

FIG. 10 is a diagram of the medium conveying path of the printer viewed from the left side of the apparatus.

FIG. 11 is a plan view illustrating disposition of the components with respect to the first path forming member.

FIG. 12 is a cross-sectional view of the shutter, the cap unit, and the first path forming member in a state in which the shutter is present at the shielding position and the cap unit is present at the lowered position.

### DESCRIPTION OF EMBODIMENTS

The present disclosure is schematically explained below.

A recording apparatus according to a first aspect of the present disclosure includes: a recording unit configured to perform recording on a medium conveyed in a first direction; a recording-time conveying path that is a medium conveying path facing the recording unit; a guide path located below the recording-time conveying path, the guide path guiding, in a second direction opposite to the first direction, the medium having passed through the recording-time conveying path; a reversing path coupled to the guide path, the reversing path reversing the medium and causing the medium to join the recording-time conveying path; a reversing roller disposed in the reversing path and configured to convey the medium downstream in the reversing path; a motor for reversing configured to drive the reversing roller; a first path forming section forming a lower surface of the recording-time conveying path; and a second path forming section forming an upper surface of the guide path, wherein the motor for reversing is disposed at a position between the first path forming section and the second path forming section.

According to this aspect, since the motor for reversing, which is a heat source, is disposed at the position between the first path forming section and the second path forming section, the first path forming section is located between the motor for reversing and the recording unit. It is possible to prevent heat generated in the motor for reversing from being transferred to the recording unit by radiation. Accordingly, it is possible to prevent the heat generation of the motor for reversing from adversely affecting the recording unit. In the following explanation, this is referred to as first action effect concerning the motor for reversing.

Since the motor for reversing is disposed at the position between the first path forming section and the second path forming section and a part or the entire motor for reversing is covered with the first path forming section, operation sound of the motor for reversing less easily leaks from the upper surface of the apparatus. In the following explanation, this is referred to as second action effect concerning the motor for reversing.

According to this aspect, it is possible to obtain at least one of the first action effect and the second action effect concerning the motor for reversing. Furthermore, since the motor for reversing is disposed at the position between the first path forming section and the second path forming section, it is possible to effectively use a space between the recording-time conveying path and the guide path. It is possible to achieve a reduction in the size of the apparatus.

A second aspect is an aspect dependent from the first aspect, the recording apparatus further including: a medium storage unit located on a lower side of the reversing path and configured to store the medium before being fed; and a pick roller configured to feed the medium from the medium storage unit, wherein the medium fed from the medium storage unit may be fed into the reversing path, and the pick roller may be driven by the motor for reversing.

When the pick roller is driven by the motor for reversing, the motor for reversing more easily generates heat. However, with the action effect of the first aspect, it is possible to prevent the heat generation of the motor for reversing from adversely affecting the recording unit.

A third aspect is an aspect dependent from the second aspect, the recording apparatus further including: a medium support unit located on the recording-time conveying path and configured to support the medium before being fed; and a feeding roller configured to feed the medium from the medium support unit, wherein the medium fed from the medium support unit may be fed to the recording-time conveying path, and the feeding roller may be driven by the motor for reversing.

When the feeding roller is driven by the motor for reversing, the motor for reversing more easily generates heat. However, with the action effect of the first aspect, it is possible to prevent the heat generation of the motor for reversing from adversely affecting the recording unit.

This aspect may be dependent from not only the second aspect but also the first aspect.

A fourth aspect is an aspect dependent from the third aspect, wherein the reversing roller, the pick roller, and the feeding roller may be located in the second direction with respect to the recording unit, and the motor for reversing may be located in the second direction with respect to the recording unit.

According to this aspect, since the reversing roller, the pick roller, and the feeding roller are located in the second direction with respect to the recording unit and the motor for reversing is also located in the second direction with respect to the recording unit, it is possible to reduce the distance between the motor for reversing and the reversing roller, the distance between the motor for reversing and the pick roller, and the distance between the motor for reversing and the feeding roller. As a result, it is possible to prevent an increase in the size of means for transmitting power from the motor for reversing to the reversing roller, means for transmitting power from the motor for reversing to the pick roller, and means for transmitting power from the motor for reversing to the feeding roller. It is possible to contribute to a reduction in the size of the entire apparatus.

A fifth aspect is an aspect dependent from the first aspect, wherein, in the motor for reversing, at least a motor main body unit may not project from the first path forming section in a width direction, which is a direction intersecting the first direction, when viewed from a normal direction with respect to a surface of the medium conveyed on the recording-time conveying path.

According to this aspect, in the motor for reversing, since at least the motor main body unit does not project in the width direction, which is the direction intersecting the first direction, from the first path forming section when viewed from the normal direction with respect to the surface of the medium conveyed on the recording-time conveying path, it is possible to effectively reduce an apparatus dimension in the width direction.

In addition, since the entire motor main body unit is covered with the first path forming section, it is possible to effectively obtain the first action effect or the second action effect.

This aspect may be dependent from not only the first aspect but also any one of the second to fourth aspects.

A sixth aspect is an aspect dependent from the first aspect, wherein the motor for reversing may be in contact with the second path forming section.

According to this aspect, since the motor for reversing is in contact with the second path forming section, it is possible to effectively transfer heat generated in the motor for reversing to the second path forming section.

Here, since the second path forming section forms the guide path and the guide path is a path used when the medium on which recording was performed by the recording unit is reversed, by raising the temperature in the guide path, it is possible to accelerate drying of the medium onto which liquid was ejected. That is, by effectively transferring the heat generated in the motor for reversing to the second path forming section, it is possible to accelerate drying of the medium onto which the liquid was ejected.

This aspect may be dependent from not only the first aspect but also any one of the second to fifth aspects.

A seventh aspect is an aspect dependent from the fourth aspect, the recording apparatus further including: a discharge path located downstream in the recording-time conveying path, the discharge path being for discharging the medium on which recording was performed; a discharge roller disposed in the discharge path and configured to feed the medium downstream in the discharge path; and a motor for discharge configured to drive the discharge roller, wherein the motor for discharge may be disposed at a position between the first path forming section and the second path forming section and in the first direction with respect to the recording unit.

In the configuration in which the recording apparatus includes the motor for discharge in addition to the motor for reversing, it is likely that heat generation by the motor for discharge in addition to the motor for reversing adversely affects the recording unit.

According to this aspect, since the motor for discharge is provided at the position between the first path forming section and the second path forming section, it is possible to prevent heat generated in the motor for discharge from being transferred to the recording unit by radiation.

Since the motor for discharge is located in the first direction with respect to the recording unit, the motor for reversing and the motor for discharge are disposed with the recording unit interposed therebetween, that is, the motor for reversing and the motor for discharge are disposed apart from each other. Accordingly, it is possible to effectively prevent heat generation by the motor for reversing and the motor for discharge from adversely affecting the recording unit.

Further, in the configuration in which the recording apparatus includes the motor for discharge in addition to the motor for reversing, noise due to the motor for discharge occurs in addition to noise due to the motor for reversing. However, since a part or the entire motor for discharge is covered with the first path forming section, operation sound of the motor for discharge less easily leaks from the upper surface of the apparatus.

This aspect may be dependent from not only the fourth aspect but also any one of the first to third aspects or any one of the fifth and sixth aspects.

An eighth aspect is an aspect dependent from the seventh aspect, the recording apparatus further including: a conveying roller disposed in the recording-time conveying path and configured to feed the medium downstream in the recording-time conveying path; and a motor for conveyance configured to drive the conveying roller, wherein the motor for conveyance may be disposed at a position between the first path forming section and the second path forming section.

In the configuration in which the recording apparatus includes the motor for conveyance in addition to the motor for reversing and the motor for discharge, it is likely that heat generation by the motor for conveyance in addition to the motor for reversing and the motor for discharge adversely affects the recording unit.

According to this aspect, since the motor for conveyance is provided at the position between the first path forming section and the second path forming section, it is possible to prevent heat generated in the motor for conveyance from being transferred to the recording unit by radiation.

Further, in the configuration in which the recording apparatus includes the motor for conveyance in addition to the motor for reversing and the motor for discharge, noise due to the motor for conveyance occurs in addition to noise due to the motor for reversing and noise due to the motor for discharge. However, since a part or the entire motor for conveyance is covered with the first path forming section, operation sound of the motor for conveyance less easily leaks from the upper surface of the apparatus.

This aspect may be dependent from not only the seventh aspect but also any one of the first to sixth aspects.

A ninth aspect is an aspect dependent from the eighth aspect, wherein the motor for discharge may be disposed in the first direction with respect to the recording unit, the motor for discharge may be disposed at one end portion with respect to the first path forming section width direction, which is a direction intersecting the first direction, and the motor for conveyance may be disposed at another end portion with respect to the first path forming section in the width direction.

According to this aspect, the motor for reversing, the motor for discharge, and the motor for conveyance are disposed apart from one another. Accordingly, it is possible to effectively prevent heat generation by the motor for reversing, the motor for discharge, and the motor for conveyance from adversely affecting the recording unit.

A tenth aspect is an aspect dependent from any one of the first to ninth aspects, wherein the first path forming section may be formed of one member formed in a shape extending in the first direction from a position facing the recording unit and extending in the second direction from a position facing the recording unit.

According to this aspect, since the first path forming section is formed by the one member having the shape extending in the first direction from the position facing the recording unit and extending in the second direction from the position facing the recording unit, it is possible to suitably prevent heat generated in the motor for reversing disposed on the lower side of the first path forming section from being transferred to the recording unit by radiation.

It is also possible to suitably prevent noise that has occurred in the motor for reversing from leaking from the upper surface of the apparatus.

An eleventh aspect is an aspect dependent from any one of the first to ninth aspects, wherein the recording unit may include a liquid ejection head configured to perform recording on the medium by ejecting liquid, the first path forming section may include an opening section at a position facing the recording unit, and the recording apparatus may further include: a cap section disposed on an inner side of the opening section and configured to switch a state in which the cap section covers a liquid ejection surface of the liquid ejection head and a state in which the cap section is separated from the liquid ejection surface; and a shutter that is displaceable to a shielding position for shielding the opening section and an opening position for opening the opening section, the shutter supporting the medium passing a position facing the liquid ejection head when the shutter is present in the shielding position.

In the configuration in which the first path forming section includes the opening section at the position facing the recording unit and the recording apparatus includes the cap section on the inner side of the opening section, it is likely that an airflow containing heat generated in the motor for reversing disposed on the lower side of the first path forming section easily flows toward the liquid ejection surface via the opening section and adversely affects liquid ejection accuracy of the liquid ejection head.

In addition, it is also likely that operation sound that occurs in the motor for reversing easily leaks upward in the apparatus via the opening section.

According to this aspect, since the recording apparatus includes the shutter that is displaceable to the shielding position for shielding the opening section and the opening position for opening the opening section, the shutter supporting the medium passing the position facing the liquid ejection head when the shutter is present in the shielding position, the opening section is closed by the shutter when recording is performed on the medium, that is, when heat is generated by the motor for reversing. Accordingly, it is possible to prevent an airflow containing the heat generated in the motor for reversing from flowing toward the liquid ejection surface via the opening section. It is possible to prevent deterioration in liquid ejection accuracy.

In addition, it is also possible to prevent operation sound that occurs in the motor for reversing from leaking upward in the apparatus via the opening section.

The present disclosure is specifically explained below.

In the following explanation, an inkjet printer 1, which is a recording apparatus that performs recording on a medium such as recording paper, is explained. In the following explanation, the inkjet printer 1 is simply referred to as printer 1.

In an X-Y-Z coordinate system illustrated in the figures, an X-axis direction is the apparatus width direction and is the width direction of the medium on which the recording is performed. When viewed from an operator of the printer 1, a +X direction is the left direction, and a −X direction is the right direction.

A Y-axis direction is the apparatus depth direction and is a direction extending along a medium conveying direction at recording time. A −Y direction is a direction from the apparatus front surface toward the apparatus rear surface, is a medium conveying direction at the time when the recording is performed, and is an example of a first direction. A +Y direction is a direction from the apparatus rear surface toward the apparatus front surface and is an example of a second direction opposite to the first direction. In the present embodiment, among side surfaces forming the periphery of the printer 1, the side surface in the +Y direction is the apparatus front surface and the side surface in the −Y direction is the apparatus rear surface.

A Z-axis direction is a direction extending along the vertical direction and is the apparatus height direction. A +Z direction is the vertically upward direction and a −Z direction is the vertically downward direction.

In the following explanation, a direction in which the medium is sent is sometimes referred to as “downstream” and the opposite direction of the direction is sometimes referred to as “upstream”.

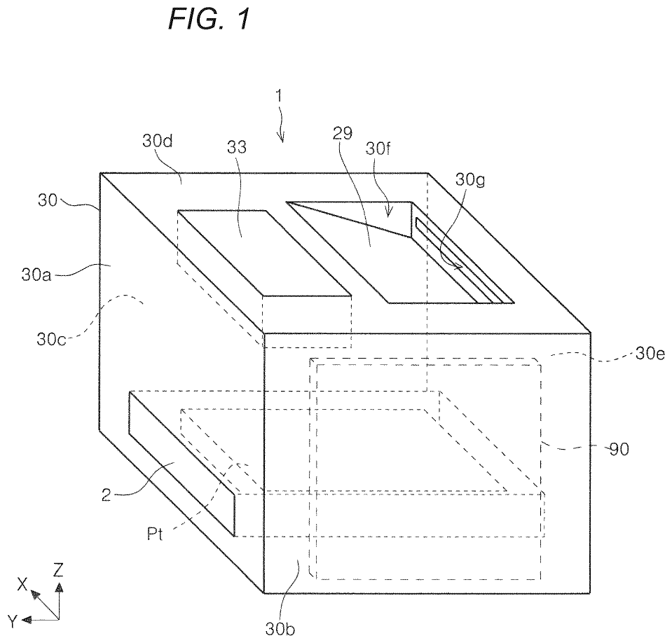

In the printer 1 illustrated in FIG. 1, an outer shell is formed by the housing 30. The housing 30 forms a front surface 30a, a right side surface 30b, a left side surface 30c, an upper surface 30d, and a rear surface 30e.

A front surface section of a medium storage cassette 2 is exposed on the front surface 30a. The medium storage cassette 2 is an example of a medium storage unit and is configured to be capable of storing a medium before being fed. The medium storage cassette 2 can be detached from the printer 1 by being pulled out in the +Y direction and can be attached to the printer 1 by being pushed in the −Y direction. In FIG. 1, reference sign Pt denotes the medium stored in the medium storage cassette 2.

A recess 30f is provided in the upper surface 30d. The bottom surface of the recess 30f is configured as the discharge tray 29. The discharge tray 29 is formed to be inclined upward in the +Y direction.

On the inside of the recess 30f, a discharge port 30g is provided to open toward the +Y direction. The medium on which the recording has been performed is discharged from the discharge port 30g in the +Y direction and is supported by the discharge tray 29 and the upper surface 30d.

A waste liquid tray 33, which is an example of

a waste liquid storage unit, is provided on the upper surface 30d. The waste liquid tray 33 is a tray that stores waste ink caused by maintenance of a line head 40 explained below, and can be detached from the printer 1 by being lifted from the upper surface 30d in the +Z direction and can be attached to the printer 1 by being dropped in the −Z direction.

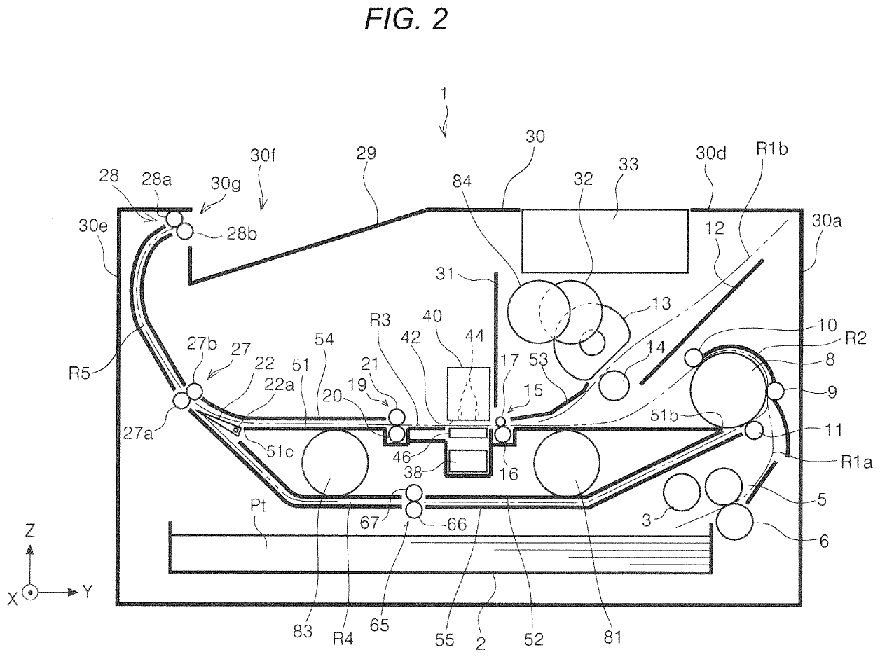

Subsequently, the medium conveying path of the printer 1 is explained with reference to FIG. 2.

The printer 1 includes a first feeding path R1a, a second feeding path R1b, a reversing path R2, a recording-time conveying path R3, a guide path R4, and a discharge path R5 as medium conveying paths for conveying media. In FIG. 2, these paths are indicated by alternate long and two dashes lines.

The first feeding path R1a is a path from the pick roller 3 at the bottom to the first nip roller 9. The second feeding path Rib is a path from a medium support unit 12 in an upper part to a first conveying roller pair 15 via a feeding roller 13. The reversing path R2 is a path from the first nip roller 9 to a second nip roller 10. The recording-time conveying path R3 is a path from the second nip roller 10 to a third conveying roller pair 27. The guide path R4 is a path from the third conveying roller pair 27 to the first nip roller 9 via a fourth conveying roller pair 65. The discharge path R5 is a path from the third conveying roller pair 27 to a discharge port 30g.

Among the paths, the recording-time conveying path R3 is a path facing a line head 40 and guides a medium in the −Y direction, which is an example of the first direction. Guiding the medium in the −Y direction is not limited to the medium conveying direction extending straight along the −Y direction and means that the medium conveying direction only has to include a −Y direction component. The guide path R4 is a medium conveying path located below the recording-time conveying path R3 and guides the medium having passed through the recording-time conveying path R3 in the +Y direction, which is an example of the second direction. Guiding the medium in the +Y direction is not limited to the medium conveying direction extending straight along the +Y direction and means that the medium conveying direction only has to include a +Y direction component.

The reversing path R2 is a medium conveying path coupled to the guide path R4 and reverses the medium and causes the medium to join the recording-time conveying path R3.

The discharge path R5 is a path located downstream in the recording-time conveying path R3, the path being for discharging, from the discharge port 30g, the medium on which recording has been performed.

The above is explained in more detail below. The printer 1 includes the medium storage cassette 2 explained above in the apparatus bottom.

A pick roller 3 is provided above the medium storage cassette 2. The pick roller 3 is capable of advancing and retracting with respect to the medium Pt stored in the medium storage cassette 2 and rotates in contact with the medium Pt stored in the medium storage cassette 2 to feed the medium from the medium storage cassette 2 in the +Y direction.

A feeding roller 5 that is driven to rotate and a separation roller 6 to which rotational torque is applied by a not-illustrated torque limiter are provided downstream of the pick roller 3. The medium fed from the medium storage cassette 2 is nipped by the feeding roller 5 and the separation roller 6 to be separated and is further fed downstream.

A reversing roller 8 that is driven to rotate is provided downstream of the feeding roller 5 and the separation roller 6. A first nip roller 9, a second nip roller 10, and a third nip roller 11 are provided around the reversing roller 8. The nip rollers are rollers capable of being driven to rotate. The medium is nipped by the reversing roller 8 and the first nip roller 9, further nipped by the reversing roller 8 and the second nip roller 10, and conveyed. The medium is reversed by the reversing roller 8 and conveyed downstream.

In the present embodiment, the reversing roller 8 is a large-diameter roller, the outer circumference of which forms the inner side of the reversing path R2. However, not only this, but the outer side and the inner side of the reversing path R2 may be formed of a path forming member and the reversing roller 8 may be a small-diameter roller disposed to face the nip rollers.

A first conveying roller pair 15 including a first driving roller 16 that is driven to rotate and a first driven roller 17 capable of being driven to rotate is provided downstream of the reversing roller 8. The first driving roller 16 is one of conveying rollers provided in the recording-time conveying path R3 and is an example of a first conveying roller.

The medium is conveyed to a position facing the line head 40 by the first conveying roller pair 15.

In addition to the medium feeding from the medium storage cassette 2, that is, the feeding using the first feeding path R1a, the printer 1 is capable of performing medium feeding from the medium support unit 12, that is, feeding using the second feeding path R1b. The medium support unit 12 supports the medium in an inclined posture. The supported medium is conveyed to the first conveying roller pair 15 by the feeding roller 13. Reference numeral 14 denotes a separation roller to which rotational torque is applied by a not-illustrated torque limiter.

The line head 40 is a liquid ejection head that ejects ink, which is an example of liquid, to the medium and performs recording and is an example of a recording unit. The line head 40 is a liquid ejection head in which a plurality of nozzles 44 for ejecting ink are arrayed to cover the entire region in the medium width direction. The line head 40 is long in the medium width direction and is configured as a liquid ejection head capable of performing recording on the entire medium width region without involving movement in the medium width direction.

Reference numeral 42 denotes a head surface facing the medium. The head surface 42 can also be referred to as liquid ejection surface or nozzle surface.

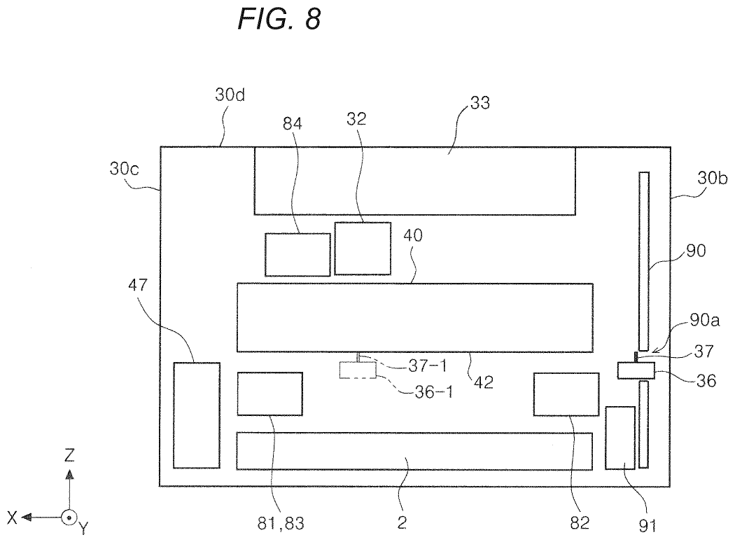

The printer 1 includes an ink storage unit 47 (see FIG. 8). The ink ejected from the line head 40 is supplied from the ink storage unit 47 to the line head 40 via a not-illustrated ink tube.

A second conveying roller pair 19 including a second driving roller 20 that is driven to rotate and a second driven roller 21 capable of being driven to rotate is provided downstream of the line head 40. The second driving roller 20 is one of conveying rollers provided in the recording-time conveying path R3 and is an example of a second conveying roller. The medium on which the recording has been performed is sent downstream by the second conveying roller pair 19.

Here, the lower surface of the recording-time conveying path R3 is formed by a first path forming section 51. The upper surface more upstream than the first conveying roller pair 15 in the recording-time conveying path R3 is partially formed by a third path forming section 53. The medium is guided to the first conveying roller pair 15 by the third path forming section 53 and the first path forming section 51. The upper surface further downstream than the second conveying roller pair 19 in the recording-time conveying path R3 is formed by a fourth path forming section 54. The medium on which the recording has been performed is guided to the third conveying roller pair 27 by the fourth path forming section 54 and the first path forming section 51.

The first path forming section 51, the third path forming section 53, and the fourth path forming section 54 may include one member or may include a plurality of members.

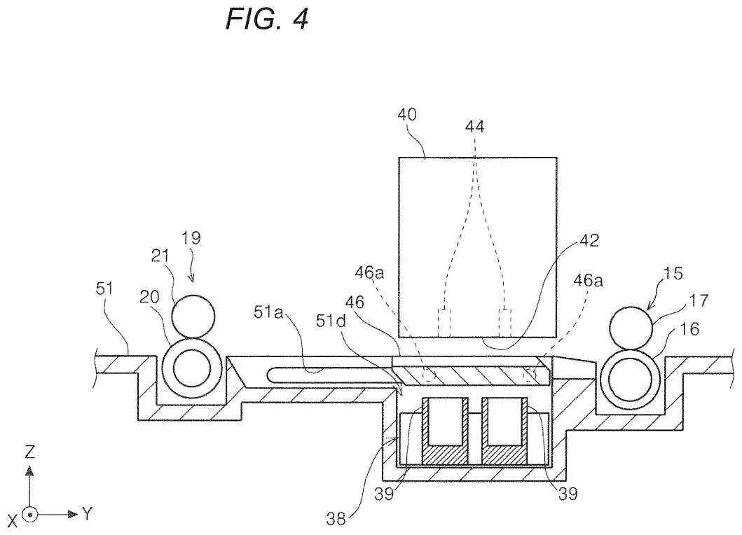

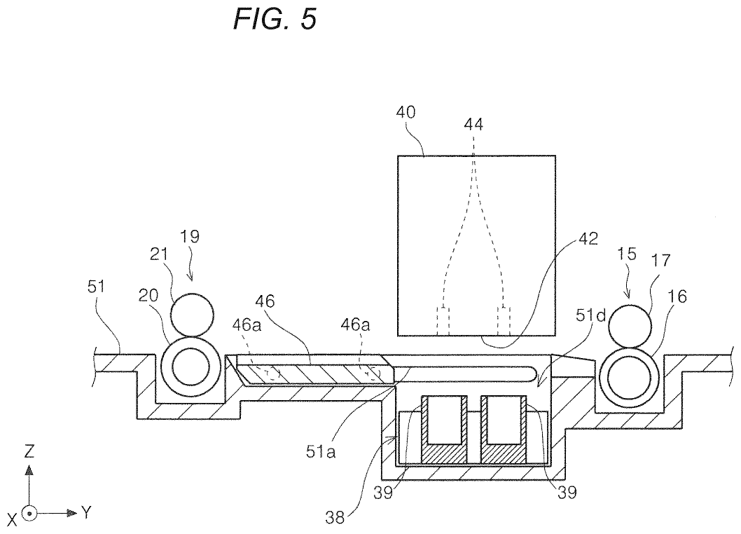

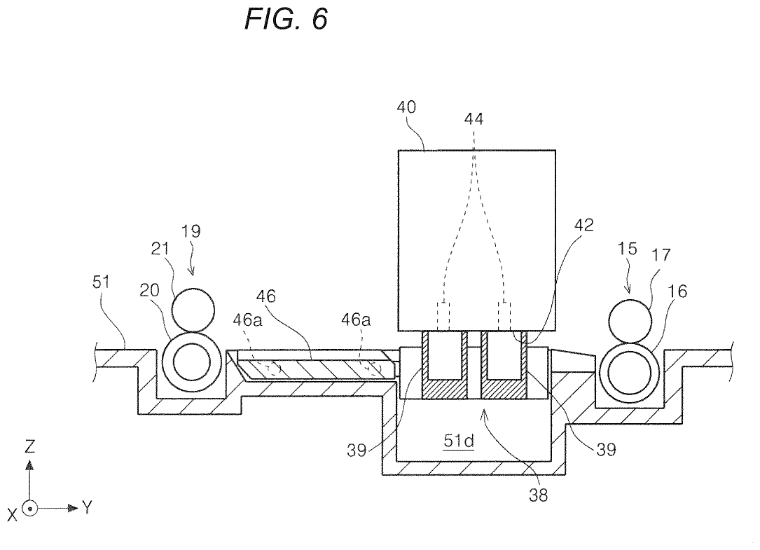

A shutter 46 is provided at a position facing the line head 40 in the recording-time conveying path R3. The shutter 46 can take a shielding position (FIGS. 2 and 4) facing the head surface 42 and an opening position (FIGS. 5 and 6) retracting from the position facing the head surface 42 by sliding in the Y-axis direction. The shutter 46 specifies a gap between the medium and the head surface 42 by supporting the medium when the shutter 46 is present in the shielding position. In the following explanation, a gap between the shutter 46 and the head surface 42 is sometimes referred to as platen gap.

The line head 40 is provided to be movable in a direction in which the line head 40 advances and retracts with respect to the shutter 46, that is, in a platen gap adjustment direction. In the present embodiment, the platen gap adjustment direction is parallel to the Z-axis direction. In the following explanation, the line head 40 moving in the +Z-axis direction is sometimes referred to as “rise” and the line head 40 moving in the −Z direction is sometimes referred to as “fall”.

A cap unit 38 is provided below the shutter 46. The cap unit 38 includes a cap section 39 (see FIGS. 4 to 6). The cap section 39 is capable of switching a state in which the cap section covers the head surface 42 and a state in which the cap section 39 is separated from the head surface 42. Operations of the shutter 46 and the cap unit 38 are explained below.

In FIG. 2, a flap 22 is provided downstream in the recording-time conveying path R3. The flap 22 is provided to be swingable centering on a swing shaft 22a by a power source (not illustrated) such as a motor or a solenoid. When the −Y direction distal end of the flap 22 falls, the medium conveyed on the recording-time conveying path R3 is fed into the discharge path R5. When the −Y direction distal end of the flap 22 rises, the medium reversely fed on the discharge path R5 can be fed to the guide path R4. The flap 22 is not limited to be driven using the power source and may be urged by a spring to maintain a posture in which, for example, the −Y direction distal end rises. In this case, the leading end of the medium moving downstream from the recording-time conveying path R3 pushes aside the flap 22 and enters the discharge path R5.

In the present embodiment, the discharge path R5 is a path for bending the medium with the surface of the medium on which recording has been performed facing inward, reversing the medium, and discharging the medium from the discharge port 30g. When recording is performed on both surfaces of the medium, bending the medium with the surface of the medium on which recording has been performed facing inward means bending the medium with the surface of the medium on which recording has been performed last facing inward. At the same time, the discharge path R5 is also a path for switching back the medium in order to feed the medium into the guide path R4.

The third conveying roller pair 27 including a third driving roller 27a that is driven to rotate and a third driven roller 27b capable of being driven to rotate is provided in the discharge path R5. The third driving roller 27a is one of discharge rollers provided in the discharge path R5 and is an example of a first discharge roller.

A fifth conveying roller pair 28 including a fifth driving roller 28a that is driven to rotate and a fifth driven roller 28b capable of being driven to rotate is provided downstream of the third conveying roller pair 27 in the discharge path R5. The fifth driving roller 28a is one of discharge rollers provided in the discharge path R5 and is an example of a second discharge roller.

When the third conveying roller pair 27 and the fifth conveying roller pair 28 normally rotate, the medium is discharged from the discharge port 30g. After the trailing end of the medium has passed the third conveying roller pair 27, when the third conveying roller pair 27 and the fifth conveying roller pair 28 reversely rotate in a state in which the −Y direction distal end of the flap 22 is raised, the medium is fed into the guide path R4 with the end portion that has been the trailing end changed to the leading end.

The fourth conveying roller pair 65 including a fourth driving roller 66 that is driven to rotate and a fourth driven roller 67 capable of being driven to rotate is provided in the guide path R4. The fourth driving roller 66 is an example of a guide roller provided in the guide path R4.

The medium fed into the guide path R4 is guided to between the reversing roller 8 and the third nip roller 11 by the fourth conveying roller pair 65 and is fed into the reversing path R2 by the reversing roller 8 and the third nip roller 11.

Reference numeral 52 denotes a second path forming section forming the upper surface of the guide path R4. Reference numeral 55 denotes a fifth path forming section forming the lower surface of the guide path R4.

The second path forming section 52 faces the flap 22 at the end portion in the −Y direction, is inclined downward from the end portion in the −Y direction in the +Y direction, then extends horizontally in the +Y direction, and thereafter is inclined upward to face the reversing roller 8 at the end portion in the +Y direction.

The fifth path forming section 55 faces the third driving roller 27a at the end portion in the −Y direction, is inclined downward in the +Y direction from the end portion in the −Y direction, then extends horizontally in the +Y direction, and thereafter is inclined upward to face the third nip roller 11 at the end portion in the +Y direction.

The second path forming section 52 and the fifth path forming section 55 may include a single member or may include a plurality of members.

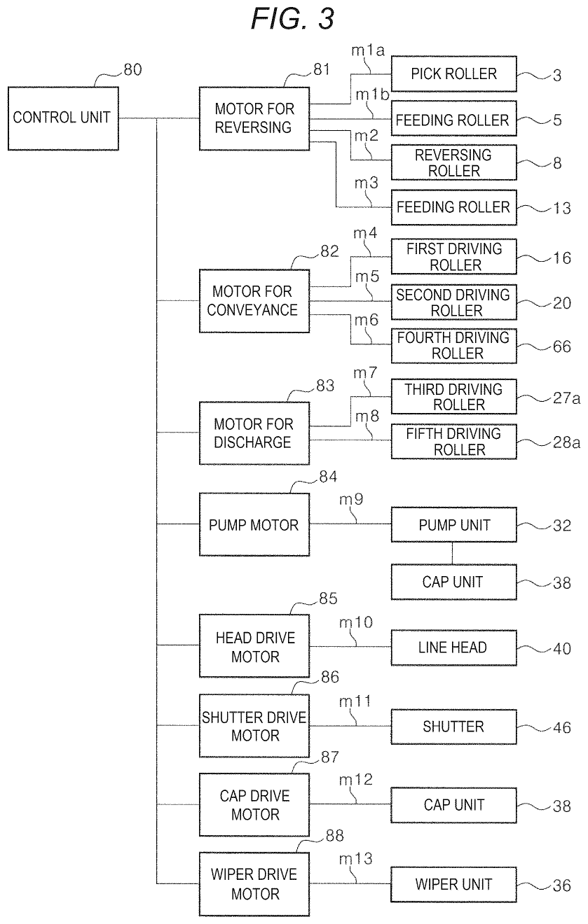

Next, a control system including a motor provided in the printer 1 is explained with reference to FIG. 3.

The control unit 80 includes a CPU and a nonvolatile memory not illustrated in FIG. 3 and executes various control programs stored in the nonvolatile memory to perform various kinds of control for the printer 1. The control unit 80 controls a plurality of motors provided in the printer 1.

A motor for reversing 81 controlled by the control unit 80 is a power source for the pick roller 3, the feeding roller 5, the reversing roller 8, and the feeding roller 13. The motor for reversing 81 transmits power to the pick roller 3 with a power transmission unit m1a. The power transmission unit m1a and other power transmission units explained below can include publicly-known power transmission means such as a gear and a drive belt unless otherwise referred to.

The motor for reversing 81 transmits power to the feeding roller 5 with a power transmission unit m1b. The motor for reversing 81 transmits power to the reversing roller 8 with a power transmission unit m2. The motor for reversing 81 transmits power to the feeding roller 13 with a power transmission unit m3.

A motor for conveyance 82 controlled by the control unit 80 is a power source for the first driving roller 16, the second driving roller 20, and the fourth driving roller 66.

The motor for conveyance 82 transmits power to the first driving roller 16 with a power transmission unit m4. The motor for conveyance 82 transmits power to the second driving roller 20 with a power transmission unit m5. The motor for conveyance 82 transmits power to the fourth driving roller 66 with a power transmission unit m6.

A motor for discharge 83 controlled by the control unit 80 is a power source for the third driving roller 27a and the fifth driving roller 28a.

The motor for discharge 83 transmits power to the third driving roller 27a with a power transmission unit m7. The motor for discharge 83 transmits power to the fifth driving roller 28a with a power transmission unit m8.

A pump motor 84 controlled by the control unit 80 drives a pump unit 32. The pump unit 32 feeds ink from the cap section 39 (see FIGS. 4 to 6) of the cap unit 38 to the waste liquid tray 33. Therefore, the cap section 39 and the pump unit 32 are coupled by a not-illustrated ink tube and the pump unit 32 and the waste liquid tray 33 are coupled by a not-illustrated ink tube.

The pump motor 84 transmits power to the pump unit 32 with a power transmission unit m9.

A head drive motor 85 controlled by the control unit 80 is a power source for raising and lowering the line head 40 in the platen gap adjustment direction. The head drive motor 85 raises and lowers the line head 40 with a power transmission unit m10. The power transmission unit m10 can include, for example, a rack and pinion mechanism including a rack (not illustrated) provided in the line head 40 and a pinion (not illustrated) meshing with the rack. The head drive motor 85 rotates the pinion.

A guide frame 31 (see FIG. 2) is disposed in the +Y direction with respect to the line head 40. The line head 40 is guided in the Z-axis direction by the guide frame 31.

A shutter drive motor 86 controlled by the control unit 80 is a power source for moving the shutter 46 in the Y-axis direction. The shutter drive motor 86 moves the shutter 46 with a power transmission unit m11. The power transmission unit m11 can include, for example, a rack and pinion mechanism including a rack (not illustrated) provided in the shutter 46 and a pinion (not illustrated) meshing with the rack. The shutter drive motor 86 rotates the pinion.

The power source for the shutter 46 is not limited to using a dedicated shutter drive motor 86. The shutter 46 may obtain power from another motor, for example, the motor for conveyance 82.

A cap drive motor 87 controlled by the control unit 80 is a power source for raising and lowering the cap unit 38 in the Z-axis direction. The cap drive motor 87 raises and lowers the cap unit 38 with a power transmission unit m12. The power transmission unit m12 can include, for example, a rack and pinion mechanism including a rack (not illustrated) provided in the cap unit 38 and a pinion (not illustrated) meshing with the rack. The cap drive motor 87 rotates the pinion.

The power source for the cap unit 38 is not limited to using a dedicated cap drive motor 87. The cap unit 38 may obtain power from another motor, for example, the head drive motor 85.

A wiper drive motor 88 controlled by the control unit 80 is a power source for moving a wiper unit 36 in the X-axis direction. As illustrated in FIG. 8, the wiper unit 36 includes a wiper 37 made of an elastic material such as rubber. The wiper unit 36 can be moved in the X-axis direction by power of the wiper drive motor 88. At that time, the wiper 37 wipes the head surface 42 of the line head 40. The wiper unit 36 has the −X direction end portion as a home position. Reference sign 36-1 denotes the wiper unit 36 moving from the home position toward the +X direction end portion. Reference sign 37-1 denotes the wiper 37 at that time.

A circuit board 90 is disposed at the home position of the wiper unit 36 (see FIG. 1 as well). The circuit board 90 configures the control unit 80. Electronic components such as an integrated circuit, a capacitor, a diode, and a transistor not illustrated in FIG. 3 are mounted on the circuit board 90. An opening section 90a is provided on the circuit board 90. When the wiper unit 36 is located at the home position, the wiper unit 36 is located on the inner side of the opening section 90a and configured such that the wiper unit 36 and the circuit board 90 do not interfere. With the configuration explained above, it is possible to reduce the X-axis direction dimension of the printer 1.

Referring back to FIG. 3, the wiper drive motor 88 moves the wiper unit 36 with a power transmission unit m13. The power transmission unit m13 includes, for example, a drive pulley (not illustrated) provided at one end portion in the X-axis direction, a driven pulley (not illustrated) provided at the other end portion, and an endless belt (not illustrated) wound around the drive pulley and the driven pulley. The wiper unit 36 is fixed to a part of the endless belt. The wiper drive motor 88 rotates the drive pulley.

Among the motors explained above, the motor for reversing 81, the motor for conveyance 82, and the motor for discharge 83 are motors relating to conveyance of the medium, are motors that operate for the longest time among the plurality of motors provided in the printer 1, and therefore generate the largest amount of heat.

Next, operations of the shutter 46 and the cap unit 38 are explained with reference to FIGS. 4, 5, and 6.

In the present embodiment, the entire first path forming section 51 is formed of one member and includes a recess 51d at a position facing the head surface 42 of the line head 40. The cap unit 38 including the cap section 39 is disposed in the recess 51d.

The recess 51d includes a guide hole 51a extending in the Y-axis direction on the side wall of the −X direction end portion and the side wall of the +X direction end portion. The shutter 46 includes, at the −X direction end portion, at intervals in the Y-axis direction, bosses 46a projecting in the −X direction and includes, at the +X direction end portion, at intervals in the Y-axis direction, bosses 46a projecting in the +X direction. The bosses 46a enter the guide hole 51a, whereby the shutter 46 is guided in the Y-axis direction by the first path forming section 51.

FIG. 4 illustrates a state in which the shutter 46 is present at the shielding position and the cap unit 38 is present at the lowered position. When performing recording on the medium, the control unit 80 maintains the shutter 46 and the cap unit 38 in the state illustrated in FIG. 4.

When the head surface 42 is covered with the cap section 39 from this state, the control unit 80 moves the shutter 46 from the shielding position to the opening position as illustrated by a change from FIG. 4 to FIG. 5. Subsequently, the control unit 80 raises the cap unit 38 as indicated by a change from FIG. 5 to FIG. 6.

When performing maintenance of the line head 40, the control unit 80 brings the shutter 46 and the cap unit 38 into a state illustrated in FIG. 6 in a recording standby state at a power-off time and a power-on time of the apparatus.

In the present embodiment, the cap section 39 covers the head surface 42 when the cap unit 38 rises and falls. However, the cap unit 38 may be fixedly provided and the cap section 39 may cover the head surface 42 when the line head 40 falls from a recording position. Alternatively, the cap section 39 may cover the head surface 42 when the line head 40 falls and the cap unit 38 rises.

Next, disposition of the motor for reversing 81, the motor for conveyance 82, and the motor for discharge 83 is explained with reference to FIGS. 2, 7, and 9.

First, the disposition of the motor for reversing 81 is explained. As illustrated in FIG. 2, the motor for reversing 81 is disposed at a position between the first path forming section 51 and the second path forming section 52. The position between the first path forming section 51 and the second path forming section 52 can also be referred to as position between the recording-time conveying path R3 and the guide path R4.

Accordingly, the first path forming section 51 is located between the motor for reversing 81 and the line head 40. It is possible to prevent heat generated in the motor for reversing 81 from being transferred to the line head 40 by radiation. It is possible to prevent the heat generation of the motor for reversing 81 from adversely affecting the line head 40. In the following explanation, this is referred to as first action effect concerning the motor for reversing 81.

The motor for reversing 81 is disposed at the position between the first path forming section 51 and the second path forming section 52 and the motor for reversing 81 is covered with the first path forming section 51. Therefore, operation sound of the motor for reversing 81 less easily leaks from the upper surface of the apparatus. In the following explanation, this is referred to as second action effect concerning the motor for reversing 81.

The heat generated in the motor for reversing 81 acts on the guide path R4, whereby it is possible to raise the temperature in the guide path R4 and accelerate drying of the medium onto which the ink has been ejected. In the following explanation, this is referred to as third action effect concerning the motor for reversing 81.

It is possible to obtain any one, two, or all of the first, second, and third action effects concerning the motor for reversing 81. Furthermore, since the motor for reversing 81 is disposed at the position between the first path forming section 51 and the second path forming section 52, it is possible to effectively use a space between the recording-time conveying path R3 and the guide path R4 and achieve a reduction in the size of the apparatus.

In the present embodiment, the motor for reversing 81 drives the pick roller 3 and the feeding roller 13 in addition to the reversing roller 8. In this case, the motor for reversing 81 is more likely to generate heat. However, with the first action effect, it is possible to prevent the heat generation of the motor for reversing 81 from adversely affecting the line head 40.

In the present embodiment, the motor for reversing 81 also drives the feeding roller 5.

In the present embodiment, the reversing roller 8, the pick roller 3, and the feeding roller 13 are located in the +Y direction with respect to the line head 40, and the motor for reversing 81 is located in the +Y direction with respect to the line head 40. Accordingly, it is possible to prevent the distance between the motor for reversing 81 and the reversing roller 8, the distance between the motor for reversing 81 and the pick roller 3, and the distance between the motor for reversing 81 and the feeding roller 13. As a result, it is possible to prevent an increase in the size of the power transmission unit m2 (refer to FIG. 3) that transmits power from the motor for reversing 81 to the reversing roller 8, the power transmission unit m1a (refer to FIG. 3) that transmits power from the motor for reversing 81 to the pick roller 3, and the power transmission unit m3 (refer to FIG. 3) that transmits power from the motor for reversing 81 to the feeding roller 13.

In the present embodiment, the feeding roller 5 is also located in the +Y direction with respect to the line head 40. Therefore, it is also possible to reduce the distance between the motor for reversing 81 and the feeding roller 5. As a result, it is also possible to prevent an increase in the size of a power transmission unit m1b (see FIG. 3) that transmits power from the motor for reversing 81 to the feeding roller 5.

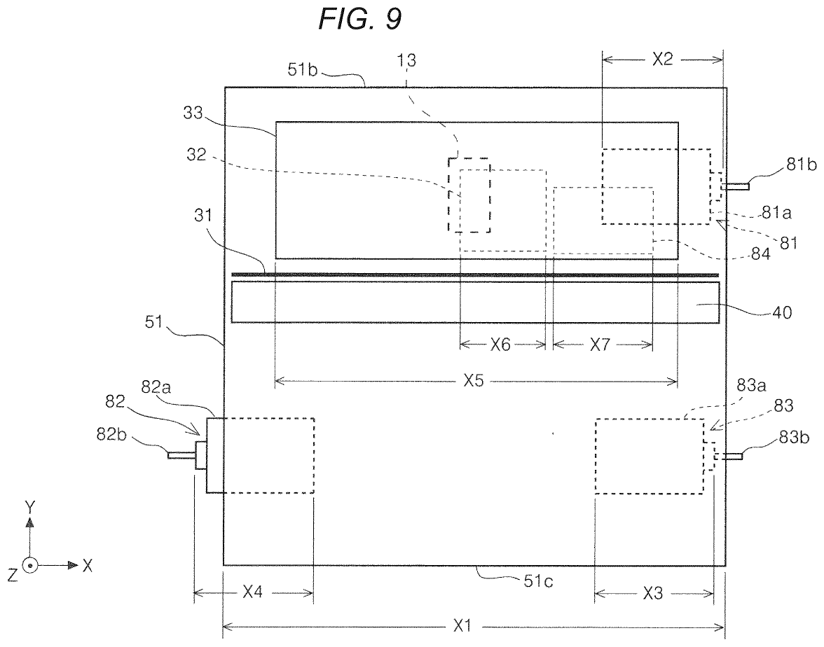

Further, in the motor for reversing 81 in the present embodiment, as illustrated in FIG. 9, at least the motor main body unit 81a does not project from the first path forming section 51 in the X-axis direction, that is, the width direction when viewed from the Z-axis direction, that is, the normal direction to the surface of the medium conveyed on the recording-time conveying path R3. In FIG. 9, reference sign X1 denotes a range occupied by the first path forming section 51 in the width direction, and reference sign X2 denotes a range occupied by the motor main body unit 81a. With the configuration explained above, it is possible to effectively reduce an apparatus dimension in the width direction. Reference sign 81b denotes a motor shaft.

In addition, since the entire motor main body unit 81a is covered with the first path forming section 51, it is possible to effectively obtain the first action effect or the second action effect concerning the motor for reversing 81.

In the motor for reversing 81 of the present embodiment, the entire motor main body unit 81a is covered with the first path forming section 51. However, a part of the motor main body unit 81a may be covered with the first path forming section 51. In the present embodiment, a part of the motor shaft 81b is covered with the first path forming section 51. However, the entire motor shaft 81b may be covered with the first path forming section 51.

The motor for reversing 81 may be configured to contact the second path forming section 52. With the configuration explained above, it is possible to effectively transfer the heat generated in the motor for reversing 81 to the second path forming section 52 and further accelerate the drying of the medium conveyed on the guide path R4. In this case, by forming the second path forming section 52 from a material having satisfactory thermal conductivity, for example, a metal material, it is possible to satisfactorily transfer the heat generated in the motor for reversing 81 to the second path forming section 52. Further, when the second path forming section 52 is formed of a material having a high thermal conductivity, for example, a metal material, the first path forming section 51 is formed of a material having a low thermal conductivity, for example, a resin material, while further accelerating the drying of the medium conveyed on the guide path R4, it is possible to effectively prevent the heat generation in the motor for reversing 81 from adversely affecting the line head 40.

Next, the disposition of the motor for discharge 83 is explained. As illustrated in FIG. 2, the motor for discharge 83 is disposed at the position between the first path forming section 51 and the second path forming section 52. Accordingly, the first path forming section 51 is located between the motor for discharge 83 and the line head 40. It is possible to prevent heat generated in the motor for discharge 83 from being transferred to the line head 40 by radiation. It is possible to prevent the heat generation of the motor for discharge 83 from adversely affecting the line head 40. In the following explanation, this is referred to as first action effect concerning the motor for discharge 83.

The motor for discharge 83 is disposed at the position between the first path forming section 51 and the second path forming section 52 and the motor for discharge 83 is covered with the first path forming section 51. Therefore, operation sound of the motor for discharge 83 less easily leaks from the upper surface of the apparatus. In the following explanation, this is referred to as second action effect concerning the motor for discharge 83. The heat generated in the motor for discharge 83 acts on the guide path R4, whereby it is possible to raise the temperature in the guide path R4 and accelerate drying of the medium onto which the ink has been ejected. In the following explanation, this is referred to as third action effect concerning the motor for discharge 83.

It is possible to obtain any one, two, or all of the first, second, and third action effects concerning the motor for discharge 83. Furthermore, since the motor for discharge 83 is disposed at the position between the first path forming section 51 and the second path forming section 52, it is possible to effectively use the space between the recording-time conveying path R3 and the guide path R4 and achieve a reduction in the size of the apparatus.

In the present embodiment, the discharge path R5 is formed in a shape for reversing the medium by bending the surface of the medium on which recording has been performed most recently, a plurality of discharge rollers are provided in the discharge path R5, and the plurality of discharge rollers include the third driving roller 27a functioning as a first discharge roller and a fifth driving roller 28a functioning as a second discharge roller located downstream of the third driving roller 27a.

When the motor for discharge 83 drives a plurality of drive targets in this way, the motor for discharge 83 more easily generates heat. However, with the action effect of the first aspect relating to the motor for discharge 83 explained above, it is possible to prevent the heat generation of the motor for discharge 83 from adversely affecting the line head 40.

The third driving roller 27a and the fifth driving roller 28a are located in the −Y direction with respect to the line head 40. The motor for discharge 83 is located in the −Y direction with respect to the line head 40. Accordingly, it is possible to reduce the distance between the motor for discharge 83 and the third driving roller 27a and the distance between the motor for discharge 83 and the fifth driving roller 28a. As a result, it is possible to prevent an increase in the size of the power transmission unit m7 (see FIG. 3) that transmits power from the motor for discharge 83 to the third driving roller 27a and the power transmission unit m8 (see FIG. 3) that transmits power from the motor for discharge 83 to the fifth driving roller 28a. It is possible to contribute to a reduction in the size of the entire apparatus.

However, the motor for discharge 83 may be located in the +Y direction with respect to the line head 40.

In the present embodiment, in the motor for discharge 83, as illustrated in FIG. 9, at least a motor main body unit 83a does not project from the first path forming section 51 in the X-axis direction, that is, the width direction when viewed from the Z-axis direction, that is, the normal direction with respect to the surface of the medium conveyed on the recording-time conveying path R3.

In FIG. 9, reference sign X3 denotes a range occupied by the motor main body unit 83a. With the configuration explained above, it is possible to effectively reduce an apparatus dimension in the width direction. Reference sign 83b denotes a motor shaft.

In addition, since the entire motor main body unit 83a is covered with the first path forming section 51, it is possible to effectively obtain the first action effect or the second action effect concerning the motor for discharge 83.

In the present embodiment, in the motor for discharge 83, the entire motor main body unit 83a is covered with the first path forming section 51. However, a part of the motor main body unit 83a may be covered with the first path forming section 51. In the present embodiment, a part of the motor shaft 83b is covered with the first path forming section 51. However, the entire motor shaft 83b may be covered with the first path forming section 51.

The motor for discharge 83 may be configured to be in contact with the second path forming section 52. With the configuration explained above, it is possible to effectively transfer the heat generated in the motor for discharge 83 to the second path forming section 52 and further accelerate the drying of the medium conveyed on the guide path R4. In this case, by forming the second path forming section 52 from a material having satisfactory thermal conductivity, for example, a metal material, it is possible to more satisfactorily transfer the heat generated in the motor for discharge 83 to the second path forming section 52. Further, by forming the second path forming section 52 from a material having satisfactory thermal conductivity, for example, a metal material and, at the same time, forming the first path forming section 51 from a material having low thermal conductivity, for example, a resin material, while further accelerating the drying of the medium conveyed on the guide path R4, it is possible to effectively prevent the heat generation in the motor for discharge 83 from adversely affecting the line head 40.

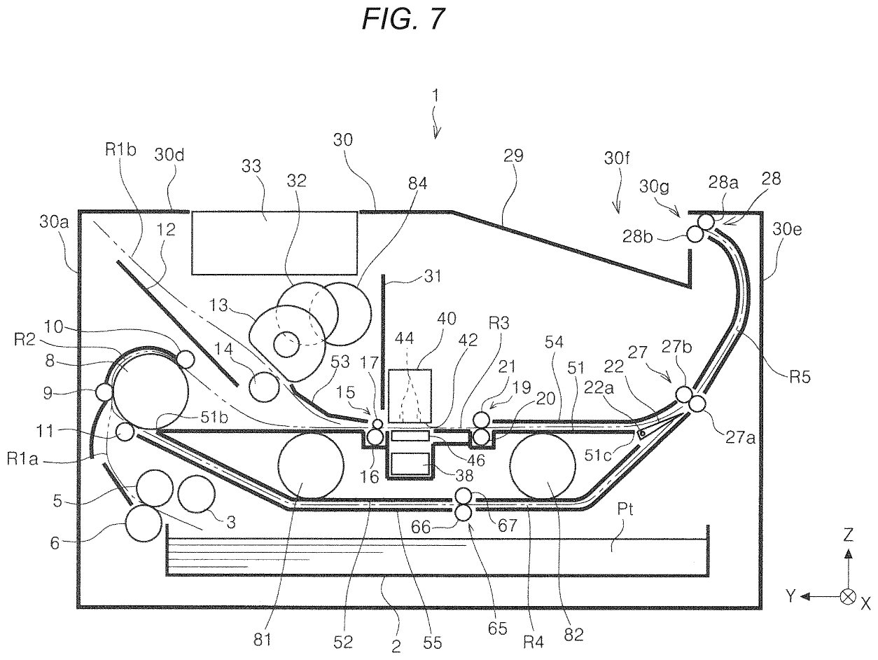

Next, the disposition of the motor for conveyance 82 is explained. As illustrated in FIG. 7, the motor for conveyance 82 is disposed at the position between the first path forming section 51 and the second path forming section 52. Accordingly, the first path forming section 51 is located between the motor for conveyance 82 and the line head 40. It is possible to prevent heat generated in the motor for conveyance 82 from being transferred to the line head 40 by radiation and prevent the heat generation of the motor for conveyance 82 from adversely affecting the line head 40. In the following explanation, this is referred to as first action effect concerning the motor for conveyance 82.

The motor for conveyance 82 is disposed at the position between the first path forming section 51 and the second path forming section 52 and the motor for conveyance 82 is covered with the first path forming section 51. Therefore, operation sound of the motor for conveyance 82 less easily leaks from the upper surface of the apparatus. In the following explanation, this is referred to as second action effect concerning the motor for conveyance 82.

The heat generated in the motor for conveyance 82 acts on the guide path R4, whereby it is possible to raise the temperature in the guide path R4 and accelerate drying of the medium onto which the ink has been ejected. In the following explanation, this is referred to as third action effect concerning the motor for conveyance 82.

It is possible to obtain any one, two, or all of the first, second, and third action effects concerning the motor for conveyance 82. Furthermore, since the motor for conveyance 82 is disposed at the position between the first path forming section 51 and the second path forming section 52, it is possible to effectively use the space between the recording-time conveying path R3 and the guide path R4 and achieve a reduction in the size of the apparatus.

A plurality of conveying rollers are provided in the recording-time conveying path R3. The plurality of conveying rollers include the first driving roller 16 functioning as a first conveying roller located upstream of the line head 40 and the second driving roller 20 functioning as a second conveying roller located downstream of the line head 40. Further, the motor for conveyance 82 drives the fourth driving roller 66 functioning as a guide roller provided in the guide path R4.

When the motor for conveyance 82 drives a plurality of driving targets, the motor for conveyance 82 more easily generates heat. However, with the action effect of the first aspect concerning the motor for conveyance 82, it is possible to prevent the heat generation of the motor for conveyance 82 from adversely affecting the line head 40.

In the present embodiment, the motor for conveyance 82 is located in the −Y direction with respect to the line head 40. However, the motor for conveyance 82 may be located in the +Y direction with respect to the line head 40.

In the present embodiment, in the motor for conveyance 82, as illustrated in FIG. 9, the motor main body unit 82a slightly projects from the first path forming section 51 in the X-axis direction, that is, the width direction when viewed from the Z-axis direction, that is, the normal direction with respect to the surface of the medium conveyed on the recording-time conveying path R3. In FIG. 9, reference sign X4 denotes a range occupied by the motor main body unit 82a. Reference sign 82b denotes a motor shaft.

However, at least the motor main body unit 82a may be disposed not to project from the first path forming section 51 in the X-axis direction, that is, the width direction. With the configuration explained above, it is possible to effectively reduce an apparatus dimension in the width direction.

In addition, since a part or the entire motor main body unit 82a is covered with the first path forming section 51, it is possible to effectively obtain the first action effect or the second action effect concerning the motor for conveyance 82.

In the present embodiment, the entire motor shaft 82b projects from the first path forming section 51 in the X-axis direction, that is, the width direction. However, a part of the motor shaft 82b may be covered with the first path forming section 51 or the entire motor shaft 82b may be covered with the first path forming section 51.

The motor for conveyance 82 may be configured to be in contact with the second path forming section 52. With the configuration explained above, it is possible to effectively transfer the heat generated in the motor for conveyance 82 to the second path forming section 52 and further accelerate the drying of the medium conveyed on the guide path R4. In this case, by forming the second path forming section 52 from a material having satisfactory thermal conductivity, for example, a metal material, it is possible to more satisfactorily transfer the heat generated in the motor for conveyance 82 to the second path forming section 52. Further, by forming the second path forming section 52 from a material having high thermal conductivity, for example, a metal material and, at the same time, forming the first path forming section 51 from a material having low thermal conductivity, for example, a resin material, while further accelerating the drying of the medium conveyed on the guide path R4, it is possible to effectively prevent the heat generation in the motor for conveyance 82 from adversely affecting the line head 40.

Subsequently, a positional relationship among the motor for reversing 81, the motor for conveyance 82, and the motor for discharge 83 is explained.

The motor for reversing 81 is located in the +Y direction with respect to the line head 40. The motor for discharge 83 is located in the −Y direction with respect to the line head 40.

With the disposition explained above, the motor for discharge 83 and the motor for reversing 81 are disposed with the line head 40 interposed therebetween, that is, the motor for discharge 83 and the motor for reversing 81 are disposed apart from each other. Accordingly, it is possible to effectively prevent the heat generation by the motor for discharge 83 and the motor for reversing 81 from adversely affecting the line head 40.

The motor for reversing 81 is located in the +Y direction with respect to the line head 40. The motor for conveyance 82 is located in the −Y direction with respect to the line head 40.

With the disposition explained above, the motor for conveyance 82 and the motor for reversing 81 are disposed with the line head 40 interposed therebetween, that is, the motor for conveyance 82 and the motor for reversing 81 are disposed apart from each other. Accordingly, it is possible to effectively prevent the heat generation by the motor for conveyance 82 and the motor for reversing 81 from adversely affecting the line head 40.

The motor for discharge 83 is disposed at the +X direction end portion, which is one end portion, with respect to the first path forming section 51 in the width direction. The motor for conveyance 82 is disposed at the −X direction end portion, which is the other end portion, with respect to the first path forming section 51 in the width direction.

Accordingly, since the motor for reversing 81, the motor for discharge 83, and the motor for conveyance 82 are disposed apart from one another, it is possible to effectively prevent the heat generation by the motor for reversing 81, the motor for discharge 83, and the motor for conveyance 82 from adversely affecting the line head 40.

In the present embodiment, the pump motor 84 and the pump unit 32 are disposed above the recording-time conveying path R3 and directly below the waste liquid tray 33 as illustrated in FIG. 2. However, the pump motor 84 and the pump unit 32 may be disposed at the position between the first path forming section 51 and the second path forming section 52.

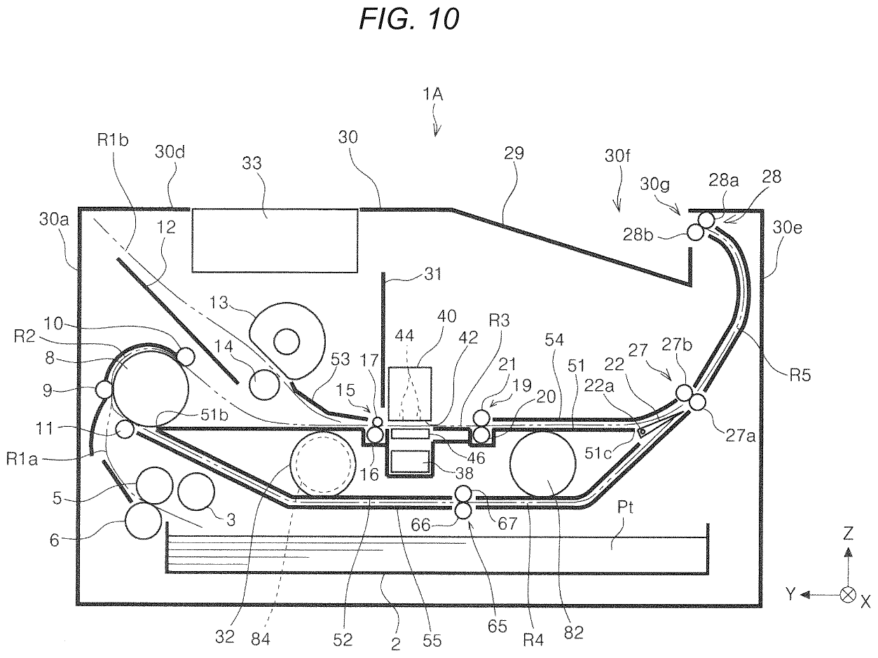

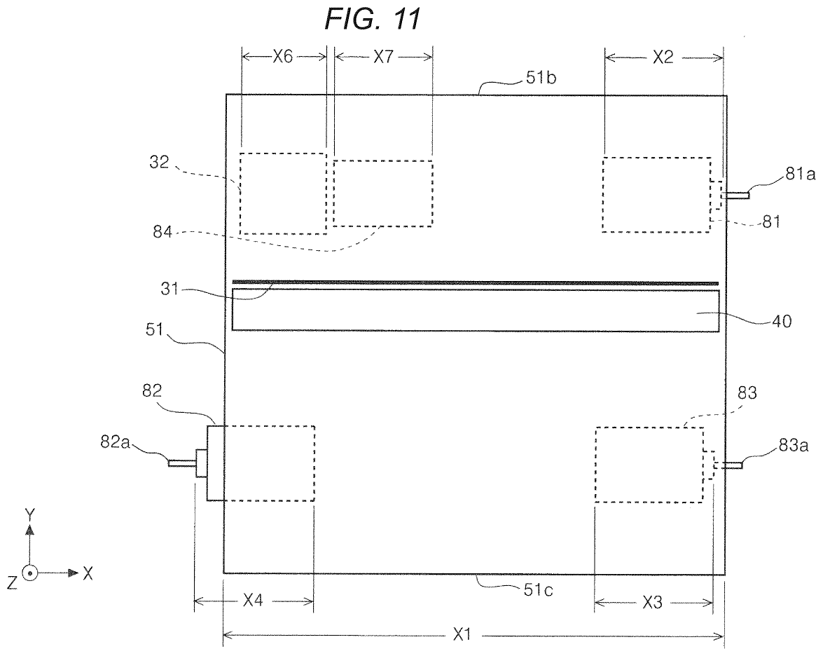

In a printer 1A illustrated in FIG. 10, the pump motor 84 and the pump unit 32 are disposed at the position between the first path forming section 51 and the second path forming section 52. The pump motor 84 and the pump unit 32 are disposed in the +Y direction with respect to the line head 40. A pair of the pump motor 84 and the pump unit 32 is disposed at a position away from the motor for reversing 81 in the width direction as illustrated in FIG. 11.

In FIG. 11, reference sign X6 denotes a region occupied by the pump unit 32 in the width direction and reference sign X7 denotes a region occupied by the pump motor 84.

As explained above, the first path forming section 51 is located between the pump motor 84 and the line head 40. It is possible to prevent heat generated by the pump motor 84 from being transferred to the line head 40 by radiation. It is possible to prevent the heat generation of the pump motor 84 from adversely affecting the line head 40. In the following explanation, this is referred to as first action effect concerning the pump motor 84.

The pump motor 84 is disposed at the position between the first path forming section 51 and the second path forming section 52 and the pump motor 84 is covered with the first path forming section 51. Therefore, operation sound of the pump motor 84 less easily leaks from the upper surface of the apparatus. In the following explanation, this is referred to as second action effect concerning the pump motor 84.

The heat generated in the pump motor 84 acts on the guide path R4, whereby it is possible to raise the temperature in the guide path R4 and accelerate drying of the medium onto which the ink has been ejected. In the following explanation, this is referred to as third action effect concerning the pump motor 84.

It is possible to obtain at least one of the first, second, and third action effects of the pump motor 84. Furthermore, since the pump motor 84 is disposed at a position between the first path forming section 51 and the second path forming section 52, it is possible to effectively use the space between the recording-time conveying path R3 and the guide path R4 and achieve a reduction in the size of the apparatus.

In addition, since the motor for reversing 81, the motor for discharge 83, the motor for conveyance 82, and the pump motor 84 are disposed apart from one another, it is possible to effectively prevent the heat generation by the motor for reversing 81, the motor for discharge 83, the motor for conveyance 82, and the pump motor 84 from adversely affecting the line head 40.

Next, the first path forming section 51 is further explained.

In the present embodiment, the first path forming section 51 is formed of one member forming a shape extending in the −Y direction from a position facing the line head 40 and extending in the +Y direction from a position facing the line head 40. Accordingly, it is possible to suitably prevent heat generated in the motors disposed on the lower side of the first path forming section 51 from being transferred to the line head 40 by radiation. It is also possible to suitably prevent noise that has occurred in the motor for reversing 81 from leaking from the upper surface of the apparatus.

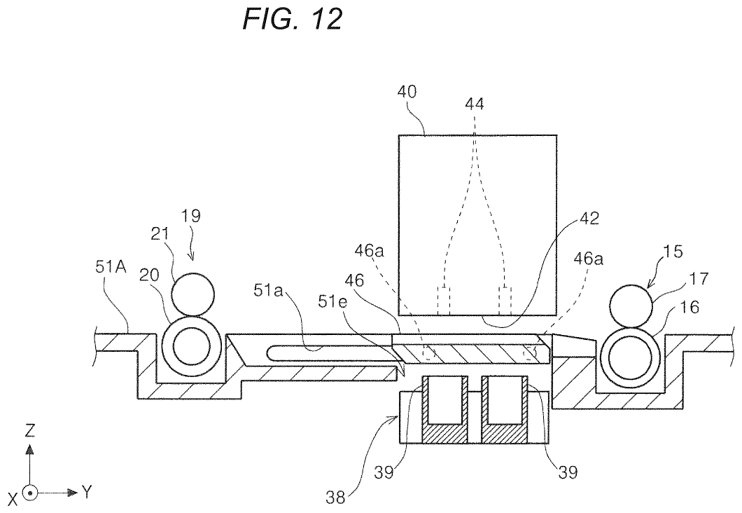

The first path forming section 51 may be an opening section instead of the recess 51d for disposing the cap unit 38. A first path forming section 51A illustrated in FIG. 12 includes an opening section 51e at a position facing the line head 40. The cap unit 38 is disposed on the inner side of the opening section 51e.

In the configuration explained above, it is likely that an airflow containing the heat generated in the motors disposed on the lower side of the first path forming section 51A easily flows toward the head surface 42 via the opening section 51e and adversely affects ink ejection accuracy of the line head 40.

In addition, it is also likely that operation sound that occurs in the motors easily leaks to upward in the apparatus via the opening section 51e.

However, when recording is performed on the medium, that is, when heat is generated in the motor for reversing 81, the motor for conveyance 82, and the motor for discharge 83, the opening section 51e is closed by the shutter 46. Accordingly, it is possible to prevent an airflow containing the heat generated in the motor for reversing 81, the motor for conveyance 82, and the motor for discharge 83 from flowing toward the head surface 42 via the opening section 51e. It is possible to prevent deterioration in ink ejection accuracy.

In addition, it is also possible to prevent operation sound that occurs in the motors from leaking to upward in the apparatus via the opening section.

Subsequently, disposition of the waste liquid tray 33, the pump motor 84, and the pump unit 32 is explained.

As illustrated in FIGS. 2 and 7, a guide frame 31 that guides the line head 40 in the Z-axis direction is provided in the +Y direction with respect to the line head 40. The guide frame 31 is a frame that forms a surface parallel to an X-Z plane and is formed of a metal material.

The waste liquid tray 33, the pump motor 84, and the pump unit 32 are disposed in the +Y direction with respect to the guide frame 31.

The pump motor 84 is disposed below the waste liquid tray 33. Accordingly, the heat generated in the pump motor 84 is transferred to the waste liquid tray 33 by radiation and convection. It is possible to accelerate drying in the waste liquid tray 33 without using a separate component such as a heat sink. It is possible to prevent an increase in cost of the apparatus. By accelerating the drying in the waste liquid tray 33, it is possible to increase an amount of waste liquid that can be stored in the waste liquid tray 33.

In the present embodiment, the pump motor 84 is disposed immediately below the waste liquid tray 33 at a position facing the bottom surface of the waste liquid tray 33.

In FIG. 9, reference sign X5 denotes a region occupied by the waste liquid tray 33 in the width direction and reference sign X7 denotes a region occupied by the pump motor 84 in the width direction. As illustrated in the drawing, the pump motor 84 does not project from the waste liquid tray 33 in the width direction when viewed from the Z-axis direction. In addition, the pump motor 84 does not project from the waste liquid tray 33 in the Y-axis direction as viewed from the Z-axis direction.

However, a part of the pump motor 84 may project from the waste liquid tray 33 in the width direction or in the Y-axis direction.

The pump unit 32 is disposed side by side with the pump motor 84 below the waste liquid tray 33. Accordingly, the power transmission unit m9 (see FIG. 3) that transmits power from the pump motor 84 to the pump unit 32 can be reduced in size.

In FIG. 9, reference sign X6 denotes a region occupied by the pump unit 32 in the width direction. As illustrated in FIG. 9, the pump unit 32 does not project from the waste liquid tray 33 in the width direction when viewed from the Z-axis direction. In addition, the pump unit 32 does not project from the waste liquid tray 33 in the Y-axis direction either when viewed from the Z-axis direction.

However, a part of the pump unit 32 may project from the waste liquid tray 33 in the width direction or in the Y-axis direction. The waste liquid tray 33 and the pump unit 32 may not overlap each other when viewed from the Z-axis direction.

The guide frame 31 separates the pump motor 84 and the line head 40. Accordingly, it is possible to prevent the heat generated in the pump motor 84 from adversely affecting the line head 40.

As illustrated in FIGS. 1 and 8, the circuit board 90 is provided beside the waste liquid tray 33. The circuit board 90 is a heat source and is configured such that heat generated in the circuit board 90 is transferred to the waste liquid tray 33 by radiation and convection. Therefore, it is possible to further accelerate the drying in the waste liquid tray 33 without using a separate component such as a heat sink.

A power supply unit 91, which is a power supply source for the apparatus, is provided at a position facing the circuit board 90 below the apparatus. The power supply unit 91 is also a heat source and is configured such that heat generated in the power supply unit 91 is transferred to the waste liquid tray 33 by convection. Accordingly, it is possible to further accelerate the drying in the waste liquid tray 33.

As illustrated in FIG. 8, the circuit board 90 and the power supply unit 91 are disposed at the end portion in the −X direction in the apparatus width direction and the ink storage unit 47 is disposed at the end portion in the +X direction in the apparatus width direction. That is, the ink storage unit 47 and the circuit board 90 and the power supply unit 91, which are heat sources that conspicuously generate heat, are disposed at positions separated from each other.

Here, when the ink ejected from the line head 40 is heated, it is likely that the viscosity of the ink deviates from a range of viscosity suitable for ejection and causes a defect such as ejection failure. However, since the ink storage unit 47 and the circuit board 90 and the power supply unit 91 are disposed at the positions separated from each other as explained above, it is possible to prevent a defect such as an ejection failure from occurring.

The pump motor 84 may be in contact with the lower surface of the waste liquid tray 33. Accordingly, the heat generated in the pump motor 84 is transferred to the waste liquid tray 33 by conduction in addition to radiation and convection. It is possible to further accelerate the drying in the waste liquid tray 33.

Other features of the printer 1 are explained below.

In FIG. 9, the motor for reversing 81 and the motor for discharge 83 are located at the end portion in the +X direction with respect to the first path forming section 51 in the width direction. However, one of the motor for reversing 81 and the motor for discharge 83 may be located at the end portion in the +X direction with respect to the first path forming section 51 and the other may be located at the end portion in the −X direction with respect to the first path forming section 51.

The motor for reversing 81 and the motor for discharge 83 overlap in the width direction.

In the present specification, when a first component and a second component are referred to as overlapping each other in a predetermined direction, a part or the entire first component and a part or the entire second component are located at the same position in the predetermined direction. In the following explanation, illustration of a range in which the first component and the second component overlap in the predetermined direction is omitted in order to avoid complication of the figures.

The motor for reversing 81 and the feeding roller 13 overlap in the Y-axis direction (see FIGS. 2 and 9).

The motor for reversing 81 and the pick roller 3 overlap in the Z-axis direction (see FIG. 2).

The motor for reversing 81 and the circuit board 90 overlap in the Z-axis direction (see FIG. 8).

The motor for reversing 81 and the medium storage cassette 2 overlap in the Y-axis direction (see FIG. 2) and further overlap in the width direction (see FIG. 8).

The motor for discharge 83 and the pick roller 3 overlap in the Z-axis direction (see FIG. 2).

The motor for discharge 83 and the circuit board 90 overlap in the Z-axis direction (see FIG. 8).

The motor for discharge 83 and the medium storage cassette 2 overlap in the Y-axis direction (see FIG. 2) and further overlap in the width direction (see FIG. 8).

The motor for conveyance 82 and the pick roller 3 overlap in the Z-axis direction (see FIG. 7).

The motor for conveyance 82 and the circuit board 90 overlap in the Z-axis direction (see FIG. 8).

The motor for conveyance 82 and the medium storage cassette 2 overlap in the Y-axis direction (see FIG. 7) and further overlap in the width direction (see FIG. 8).

The pump motor 84 and the first path forming section 51 overlap in the width direction and overlap in the Y-axis direction (see FIG. 9).

The pump motor 84 and the motor for reversing 81 overlap in the width direction and overlap in the Y-axis direction (see FIG. 9).

The pump motor 84 and the feeding roller 13 overlap in the Y-axis direction (see FIGS. 2 and 7).

The pump motor 84 and the circuit board 90 overlap in the Z-axis direction (see FIG. 8).

The pump motor 84 and the medium storage cassette 2 overlap in the Y-axis direction (see FIGS. 2 and 7) and further overlap in the width direction (see FIG. 8).

In the present embodiment, the pump motor 84 and the reversing roller 8 do not overlap in the Z-axis direction (see FIGS. 2 and 7). However, the pump motor 84 and the reversing roller 8 may overlap in the Z-axis direction.

The waste liquid tray 33 and the feeding roller 13 overlap in the Y-axis direction (see FIGS. 2, 7, and 9). The feeding roller 13 is located below the waste liquid tray 33. The feeding roller 13 is located at the center position in the width direction (see FIG. 9).

The waste liquid tray 33 is disposed on the upper surface 30d of the housing 30, that is, on the horizontal plane of the upper surface of the printer 1 (see FIGS. 1, 2, and 7).

The waste liquid tray 33 is located in the +Y direction with respect to the line head 40.

The waste liquid tray 33 and the circuit board 90 overlap in the Z-axis direction (see FIG. 8).

The waste liquid tray 33 and the medium storage cassette 2 overlap in the Y-axis direction (see FIG. 7) and further overlap in the width direction (see FIG. 8).

The present disclosure is not limited to the embodiment and the modifications explained above. Various modifications are possible within the scope of the disclosure described in the claims. It is needless to say that the modifications are also included within the scope of the present disclosure.

What is claimed is:

1. A recording apparatus comprising:
a recording unit configured to perform recording on a medium conveyed in a first direction;
a recording-time conveying path that is a medium conveying path facing the recording unit;
a guide path located below the recording-time conveying path, the guide path guiding, in a second direction opposite to the first direction, the medium passed through the recording-time conveying path;
a reversing path coupled to the guide path, the reversing path reversing the medium and causing the medium to join to the recording-time conveying path;
a reversing roller disposed in the reversing path and configured to feed the medium downstream in the reversing path;
a motor for reversing configured to drive the reversing roller;
a first path forming section forming a lower surface of the recording-time conveying path; and
a second path forming section forming an upper surface of the guide path, wherein
the motor for reversing is disposed at a position between the first path forming section and the second path forming section.

2. The recording apparatus according to claim 1, further comprising:
a medium storage unit located on a lower side of the reversing path and configured to store a medium before being fed; and
a pick roller configured to feed the medium from the medium storage unit, wherein
the medium fed from the medium storage unit is fed to the reversing path, and
the pick roller is driven by the motor for reversing.

3. The recording apparatus according to claim 2, further comprising:
a medium support unit located on the recording-time conveying path and configured to support a medium before being fed; and
a feeding roller configured to feed the medium from the medium support unit, wherein
the medium fed from the medium support unit is fed to the recording-time conveying path, and
the feeding roller is driven by the motor for reversing.

4. The recording apparatus according to claim 3, wherein
the reversing roller, the pick roller, and the feeding roller are located in the second direction with respect to the recording unit, and
the motor for reversing is located in the second direction with respect to the recording unit.

5. The recording apparatus according to claim 1, wherein, in the motor for reversing, at least a motor main body unit does not project from the first path forming section in a width direction, which is a direction intersecting the first direction, when viewed from a normal direction with respect to a surface of the medium conveyed on the recording-time conveying path.

6. The recording apparatus according to claim 1, wherein the motor for reversing is in contact with the second path forming section.

7. The recording apparatus according to claim 4, further comprising:
a discharge path located downstream in the recording-time conveying path, the discharge path being for discharging the medium on which recording was performed;
a discharge roller disposed in the discharge path and configured to feed the medium downstream in the discharge path; and
a motor for discharge configured to drive the discharge roller, wherein
the motor for discharge is disposed in the first direction with respect to the recording unit at a position between the first path forming section and the second path forming section.

8. The recording apparatus according to claim 7, further comprising:
a conveying roller disposed in the recording-time conveying path and configured to feed the medium downstream in the recording-time conveying path; and
a motor for conveyance configured to drive the conveying roller, wherein
the motor for conveyance is disposed at a position between the first path forming section and the second path forming section.

9. The recording apparatus according to claim 8, wherein
the motor for discharge is disposed in the first direction with respect to the recording unit,
the motor for discharge is disposed at one end portion with respect to the first path forming section in a width direction, which is a direction intersecting the first direction, and
the motor for conveyance is disposed at another end with respect to the first path forming section in the width direction.

10. The recording apparatus according to claim 1, wherein the first path forming section is formed of one member formed in a shape extending in the first direction from a position facing the recording unit and extending in the second direction from a position facing the recording unit.

11. The recording apparatus according to claim 1, wherein
the recording unit includes a liquid ejection head configured to perform recording on the medium by ejecting liquid,
the first path forming section includes an opening section at a position facing the recording unit, and
the recording apparatus further comprises:
a cap section disposed on an inner side of the opening section and configured to switch a state in which the cap unit covers a liquid ejection surface of the liquid ejection head and a state in which the cap unit is separated from the liquid ejection surface; and
a shutter that is displaceable to a shielding position for shielding the opening section and an opening position for opening the opening section, the shutter supporting the medium passing a position facing the liquid ejection head when the shutter is present in the shielding position.
